(19) United States
(12) Patent Application Publication
(10) Pub. No.: US 2016/0059641 A1
(43) Pub. Date: Mar. 3, 2016

(54) Tubeless Wheel

(71) Applicant: Steven Craig Bast, Lombard, IL (US)

(72) Inventor: Steven Craig Bast, Lombard, IL (US)

(21) Appl. No.: 14/837,966

(22) Filed: Aug. 27, 2015

Related U.S. Application Data
(60) Provisional application No. 62/042,892, filed on Aug. 28, 2014.

(51) Int. Cl. B60C 15/02; B60C 5/10

(52) U.S. Cl. CPC B60C 15/0226; B60C 15/0203; B60C 5/10

(57) ABSTRACT

The present invention provides a solid light weight nylon foam rod of a particular diameter that is fused together to form a continuous ring that is of a specified circumference, to provide a seal between the inner beads of a standard bicycle tire so when air is pumped through the air valve it creates an air lock between the inner tire area and the nylon foam surface. When mounted on a standard bicycle wheel rim with a standard bicycle tire will create a tubeless bicycle wheel.

### RELATED APPLICATIONS

This application claims the benefit of U.S. Provisional Application No. 62/042,892 filed Aug. 28, 2014 and herein incorporated by reference.

### STATEMENT REGARDING FEDERALLY SPONSORED RESEARCH & DEVELOPMENT

Not applicable.

### INCORPORATION BY REFERENCE OF MATERIAL SUBMITTED ON A COMPACT DISC

Not applicable.

### BACKGROUND OF THE INVENTION

The present invention relates to tubeless bicycle tires, and the progressive movement towards bicycle wheel flat protection and performance. For over ten years, the mountain bike style wheel has used a tubeless design to help with flat protection from thorns when used with tire sealant that has been designed for bicycles. Some other performance gains are a lighter overall wheel, and less rolling resistance because no tube is utilized for inflation. Another advantage is using lower pressure in the tires for better grip and handling especially in cycle cross, but with that sought after low-pressure comes a risk of bottoming out the rim on sharp objects. This will result in either a flat or a sudden loss of air with the tire bead pulling away from the rim (tire burping). Other issues have been the trial and error of finding tires that are of proper fit so as to eliminate upon tire installation sealing problems and low-pressure tire burping.

### BRIEF SUMMARY OF THE INVENTION

In one embodiment, the invention provides a tubeless wheel using a standard beaded tire and rim. In particular, a specific embodiment of the invention provides a tubeless bicycle wheel using a standard beaded bicycle tire and a standard hook shape bicycle rim.

The present invention resolves the main issue of tire burping, and bottoming out the wheel when using low pressure for performance. The present invention provides a cushion between the rim and sharp objects to protect the rim from damage. The present invention also enables the user to select any tire and rim combination without concern of proper fit. The present invention also gives the user the ability to ride on the tire if a flat is incurred with a cut that is larger than the sealant can seal or until a repair can be made. Another benefit of using the invention is the ease of installation, because sealing the void between the tire beads is done by the insert or seal when setting the tire on the bead seat area.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

In the drawings, which are not necessarily drawn to scale, like numerals may describe substantially similar components throughout the several views. Like numerals having different letter suffixes may represent different instances of substantially similar components. The drawings illustrate generally, by way of example, but not by way of limitation, a detailed description of certain embodiments discussed in the present document.

FIG. 1 is a cross-sectional view of one embodiment of the present invention.

FIG. 2 is a cross-sectional view of a valve that may be used with one embodiment of the present invention.

FIG. 3A is a cross-sectional view of one embodiment of the present invention.

FIG. 3B is an exploded view of one embodiment of the present invention taken at line 3B.

FIG. 4 illustrates another embodiment of the present invention.

### DETAILED DESCRIPTION OF THE INVENTION

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a representative basis for teaching one skilled in the art to variously employ the present invention in virtually any appropriately detailed method, structure or system. Further, the terms and phrases used herein are not intended to be limiting, but rather to provide an understandable description of the invention.

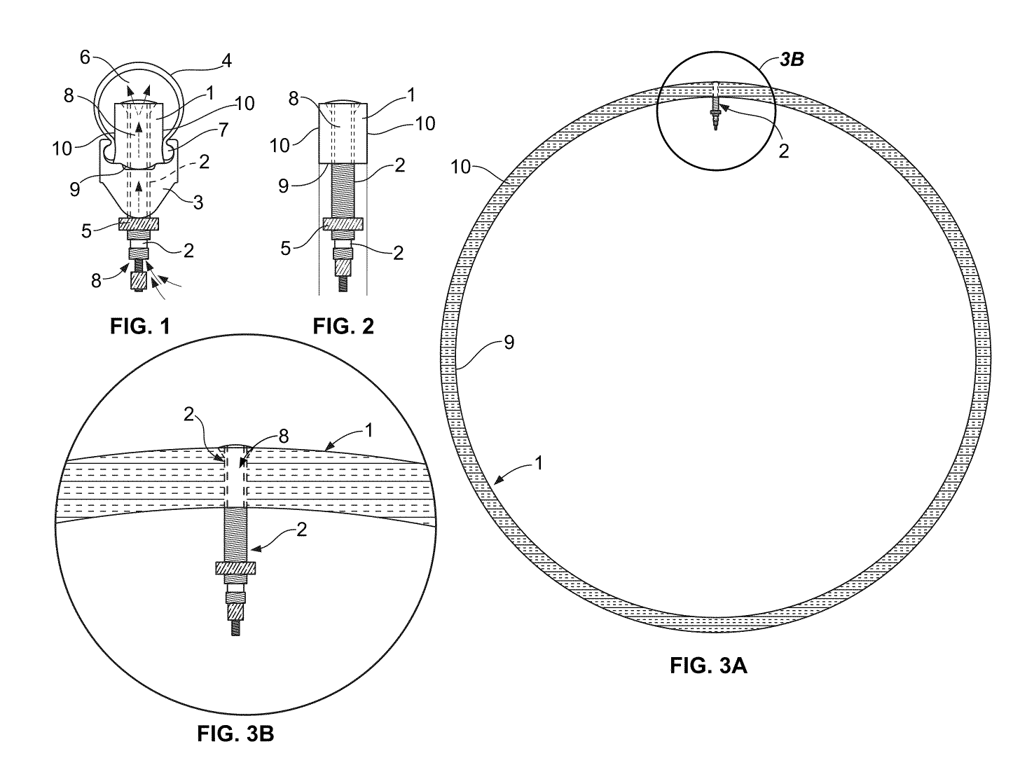

As shown in FIGS. 1, 2, 3A and 3B, in one embodiment, the present invention provides an apparatus and method that seals and locks a standard beaded tire (4) onto a standard hook style bicycle rim (3); so no tube is needed for retaining air pressure in the tire (4). Insert (1), which may be a nylon seal or foam, may be manufactured to a round rod that is of a specific size so as to provide pressure up against the tire bead (7). Insert (1) is coated with installation lube (10), which facilitates assembly and allows the insert or nylon seal (1) to slide into position between the tire beads (7). This creates an air lock chamber (6) and secures the tire beads (7). Once the assembly is complete the present invention creates an air lock that retains air in the tire chamber (6), locks the tire beads (7) into place and provides a wheel rim (3) damper for when objects are struck. As a benefit of a tubeless design, it is lighter than a wheel with a tube, and performance is increased with lower rolling resistance, flat protection sealant can also be used because there is no tube.

In yet another embodiment, the present invention provides insert 1, which may be constructed as described above or be of a pliable material. Insert 1 is stretched around the outer diameter of the inner part of the wheel rim 3, and up against the rim's inner surface between the rim's sides. Adhesive sealant 9 on the inside of the insert 1 provides an airtight seal between the insert 1 and the rim's inner diameter wall. Tire 4 is placed around the insert and rim. Sealant 10 is then applied to both sides of the insert's walls so that an airtight seal is created when mounting the tire beads. The tire beads 7 can then be fitted between the insert and rim. An air pump is then connected to the valve 2 to provide the correct amount of air pressure. The air pressure flows through the valve and passageway 8 in insert 1 creating an air lock 6 between the insert and the tire for proper tire inflation. When a proper air pressure lock is created between the insert and the tire, it pushes the insert 1 up against the rim's inner diameter wall and tire bead 7 making a tighter airtight seal. The wheel is next filled to specified pressure, and is then ready for operation. With the insertion of the insert 1, it takes the place of the bicycle rim tape and tube.

Insert 1 guards against pinch flats (when an object is struck and the tire pinches the tube against the rim resulting in a flat), and helps with protection against bottoming out the rim on abrupt impacts, because insert 1 takes some of the compression when the tire 4 is compressed. With insert 1, there is less rolling resistance, and less total weight of the bicycle wheel assembly (because there is no tube), which will provide faster acceleration and speed. Lower cost of maintenance, because most flats are from pinch flats is also provided.

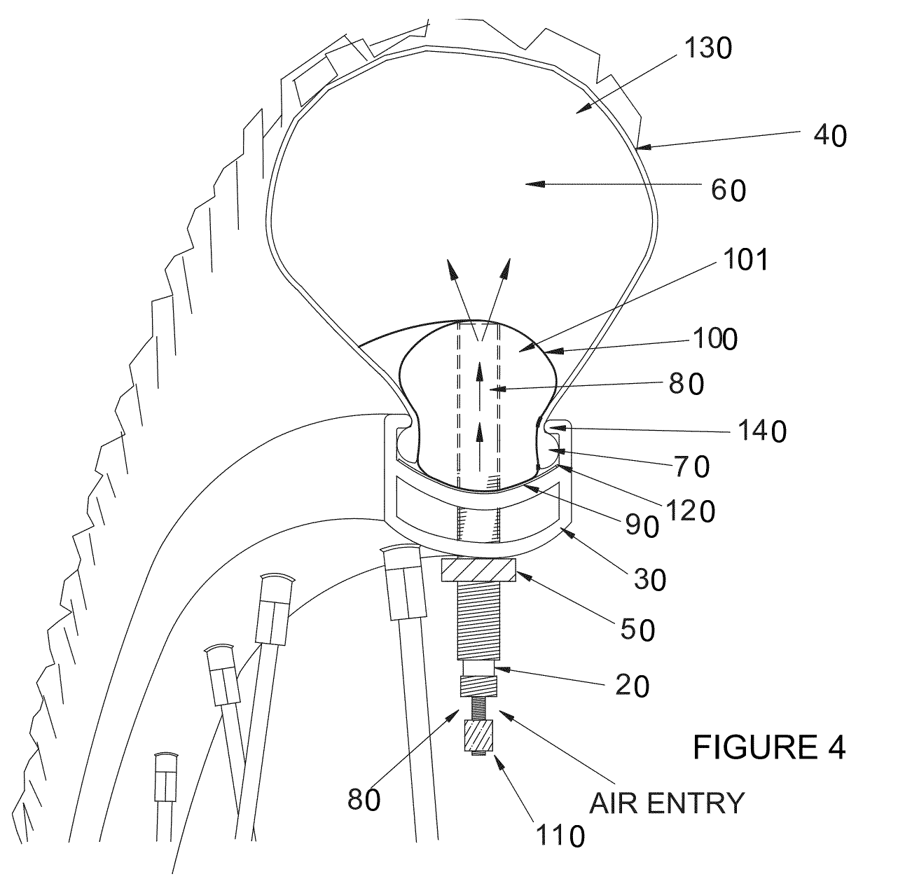

As shown in FIG. 4, in yet other embodiments, the present invention is composed of a solid light weight nylon foam that has a density of 4.3 pounds per cubic ft. The nylon foam rod (101) is manufactured to a diameter that is approximately 0.1 inches larger than the distance between the wheel rim hooks (140). The circumference of the nylon foam rod (101) is of a size that provides tension when installed, and is 75 inches long or appropriately sized to engage the circumference of the rim before being the ends of the rod are fused together. The presta valve (20) is threaded into the nylon foam rod (100) with adhesive on it to secure it in place. A coating of Petroleum jelly (100) is wiped on the nylon foam rod (101) for installation after it is fused together, and the presta valve (20) is installed. Rim tape (90) is added if the existing rim tape that came with the wheel is not air tight. The nylon foam rod (101) is placed inside the tire (40) and assembled onto the wheel rim (30), with the presta valve (20) as the starting point of the assembly. Nylon foam rod (101) may be installed onto the rim (30) prior to working tire (40) onto wheel rim (30). The last portion of the tire bead (70) is mounted last. Once the tire (40) is centered by hand evenly on the wheel rim (30) the presta valve nut (50) is threaded by hand on the presta valve (20). The presta valve lock nut (110) is loosened so the presta valve (20) air passage way (80) is clear for filling with compressed air by a floor pump. The pump is connected to the presta valve (20) to fill the air chambers (60) to 40-50 PSI so as to seat the tire (40) on the wheel rim bead seat area (120), and force the nylon foam rod seal (101) down on the rim (30) between the tire beads (70). The tire can then be deflated and flat protection sealant is added through the presta valve (20) that is of a non-aqueous kind. The tire (40) is inflated back to a desired pressure of no more than 60 PSI.

In other aspects, the present invention provides a method of creating a tubeless tire that makes a standard bicycle tire, and a standard hooked bicycle rim, into a tubeless design requiring no tube for inflation of the tire. The nylon foam rod seal is inserted, which is 3 to 4 times lighter than a butyl bicycle tube, resulting in a lighter wheel. The insert acts as a seal and retainer for the tire bead area, and protects the rim against objects when struck while riding. The nylon foam rod seal insert eliminates air burping when running with low tire pressure for attaining lower rolling resistance, and better tire grip is a result as well. The rod may also be a solid light weight nylon foam that has a density of 4.3 pounds per cubic foot.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above described embodiments, methods, and examples, but by all embodiments and methods within the scope and spirit of the disclosure.

What is claimed is:

1. A bicycle wheel comprising:
a valve;
a rim defining a center channel;
a tire received in said channel of said rim, said tire defining an air chamber;
said rim having outwardly extending and opposingly located rim hooks positioned to receive a pair of tire beads;
a deformable insert adapted to seat within said channel and sized to exert pressure against said beads to urge said beads against said bead flanges;
a passageway in said insert, said passageway in communication with said valve to permit pressurized air to be received in said air chamber; and
said insert adapted to deform in response to said pressurized, said deformation causes said insert to exert pressure against said tire and said beads to form a mechanical air tight seal between said tire and said rim.

2. The bicycle wheel of claim 1 wherein a portion of said valve is received by said insert.

3. The bicycle wheel of claim 1 wherein said insert is a nylon foam rod having a diameter that is approximately 0.1 inches larger than the distance between said rim hooks.

4. The bicycle wheel of claim 3 wherein said rod has ends which are adapted to be joined together to form a circular insert.

5. The bicycle wheel of claim 4 wherein said circular insert is adapted and sized to be stretched around said rim.

6. The bicycle wheel of claim 3 wherein at an air chambers pressure of 40-50 PSI, said nylon rod is forced against said tire to form an air tight seal.

7. The bicycle wheel of claim 3 wherein said rod is a solid light weight nylon foam that has a density of 4.3 pounds per cubic foot.

8. The bicycle wheel of claim 3 wherein said rod has a circular cross-section.

9. The bicycle wheel of claim 3 wherein said rod has a non-uniform cross-section.

10. The bicycle wheel of claim 3 wherein said rod has a uniform cross-section.

11. A method of creating a tubeless bicycle wheel, said wheel having a rim and tire comprising:
providing a solid deformable rod having a passageway therein and opposing ends;
locating a valve in said passageway;
fusing said ends together to form a continuous insert;
affixing said insert to said rim;
placing said tire on said rim and sandwiching a pair of tire beads between said insert and said rim; and
filling said tire with air to fill an air chamber formed by said tire to 40-50 PSI so as to seat the tire on the rim and to force the insert down on the rim between the tire beads to form an air tight seal between the tire and the rim.

12. The method of claim 11 further including the step of deflating the tire after seating, adding a sealant and re-inflating the tire.

13. The method of claim 11 further including of coating said rod with a lubricant after said ends are fused together.

14. The method of claim 11 wherein said insert is a nylon foam rod having a diameter that is approximately 0.1 inches larger than the distance between said rim hooks.

15. The method of claim 11 wherein said rod is a solid light weight nylon foam that has a density of 4.3 pounds per cubic foot.

16. The method of claim 11 wherein said rod has a circular in cross-section.

17. The method of claim 11 wherein said insert extends past said rim hooks a sufficient distance to permit said insert to support said tire and to maintain the operation of said tire when said tire is deflated.

18. The bicycle wheel of claim 1 wherein said insert extends past said rim hooks a sufficient distance to permit said insert to support said tire and to maintain the operation of said tire when said tire is deflated.

19. The bicycle wheel of claim 1 wherein said tire is tubeless.

20. The method of claim 11 wherein said tire is tubeless.
